(19) United States
(12) Patent Application Publication
(10) Pub. No.: US 2012/0057483 A1
(43) Pub. Date: Mar. 8, 2012

(54) Frame Structure For Multi-Input Multi-Output

(75) Inventors: Joon Bae Kim, Lexington, MA (US); Richard Gross, Acton, MA (US); Vladimir Oksman, Morganville, NJ (US)

(73) Assignee: LANTIQ DEUTSCHLAND GMBH, Neubiberg (DE)

(21) Appl. No.: 13/227,499

(22) Filed: Sep. 8, 2011

Related U.S. Application Data
(60) Provisional application No. 61/381,064, filed on Sep. 8, 2010.
(60) Provisional application No. 61/381,426, filed on Sep. 9, 2010.

(51) Int. Cl. H04W 4/00; H04W 24/00

(52) U.S. Cl. 370/252; 370/328

(57) ABSTRACT

Described herein are implementations related to data communication using a frame that includes at least two data packets. One of the data packets includes a preamble that is separated from a payload by a gap, void or empty space. Another of the data packets includes a preamble that is aligned with the gap, void or empty space. A receiver of the frame may perform channel measurements during the gap, void or empty space.

### RELATED APPLICATION

This application claims the benefit of priority to U.S. Provisional Patent Application Ser. No. 61381064, filed on 8 Sep. 2010, and U.S. Provisional Patent Application Ser. No. 61381426, filed on 9 Sep. 2010, the disclosures of which are incorporated by reference herein.

### BACKGROUND

Data packet transmission in multipoint-to-multipoint networks (e.g., ad-hoc or mesh networks) is usually arranged by sending one or more data packets. A data packet is often encoded and modulated. Also, a data packet typically includes at least one frame. Each frame is preceded by a preamble. The primary purposes of the preamble include 1) enabling the receiver of the frame to detect the frame on the transmission medium, 2) adjusting the gain of the receiver (e.g., an analog front end (AFE)) and synchronizing the clock so that frame is received when expected. The frame also has a header that carries information helping the receiver to address, demodulate, and decode the frame.

Because of their ubiquitous nature, powerlines are increasing in popularity as a transmission medium for many networks that use data packet transmission techniques. For example, Power Line Communication (PLC), also called Mains Communication, Power Line Transmission (PLT), Broadband Powerline (BPL), Powerband or Power Line Networking (PLN), is a term describing several different systems for using power distribution wires for simultaneous distribution of data. PLC is presently standardized in a number of protocol including the Powerline protocol, ITU G.hn or hnem, and HomePlug AV, for example. PLC systems can communicate voice and data by superimposing a signal(s) over standard 50 or 60 Hz alternating current (AC). For indoor applications, PLC equipment can use household electrical power wiring as a transmission medium.

Most AC power outlets have 3 connections, phase (P), neutral (N), ground (G). A PLC system can utilize two independent channels provided by these three connections (e.g., P-N pair for one channel and N-G pair for another channel). Utilizing more than two channels is also possible. Without loss of generality, only two channels are assumed in this disclosure for the simplicity of description and illustration.

A Single-Input Single-Output (SISO) PLC system often utilizes P-N pair for its communication channel because of its ubiquitous availability. However, emerging PLC Multi-Input Multi-Output (MIMO) technology takes advantage of the remaining communication channel(s) to increase spectral efficiency and throughput.

Since most deployed PLC modems are designed to operate in a SISO system, one important requirement of a PLC MIMO system is interoperability with existing SISO systems. Since MIMO channels are not completely orthogonal or electrically isolated, signals transmitted over two or more channels may interfere with each other. Therefore, it is desirable to construct a physical layer (PHY) frame structure that enables performance enhancements from MIMO systems without causing performance degradation in existing SISO systems.

### SUMMARY

Described herein are implementations related to data communication using a frame that includes at least two data packets. One of the data packets includes a preamble that is separated from a payload by a gap, void or empty space. Another of the data packets includes a preamble that is aligned with the gap, void or empty space. A receiver of the frame may perform channel measurements during the gap, void or empty space.

The described implementations are particularly useful in systems that employ Multi-Input Multi-Output (MIMO). In particular, the various frame implementations described herein enable a receiver of an implementation specific frame to reliably execute communication and interference measurements on the channels of a MIMO system. In addition, the frames implemented by the described implementations are compatible with Single-Input Single-Output (SISO) systems, support various MIMO schemes, e.g., space time diversity and spatial multiplexing, and enable simplified transceiver design.

In a first aspect, there is provided an apparatus comprising a frame construction unit configured to construct a frame. The frame may include a packet including a first and second part, the first part separated from the second part by a quiet period gap; and another packet including a third part, the third part aligned with at least a portion of the quiet period gap. a A solution provides a transmission unit configured to transmit the frame over a communication medium. In comparison with previous problems, at least one effect of the apparatus of the solution provided in the first aspect is the mitigation of interference caused when two packets of a frame are transmitted on channels of a MIMO system.

In refinement of the first aspect the first part of the packet includes at least a preamble and the third part of the another packet includes at least a preamble and header.

In a refinement of the first aspect the frame is a Multi-Input Multi-Output (MIMO) frame. In a particular embodiment, the MIMO frame includes the packet and the another packet.

In a refinement of the first aspect the transmission unit is further configured to transmit by utilizing Orthogonal Frequency-Division Multiplexing (OFDM).

In a refinement of the first aspect the first part of the packet includes at least a preamble and the third part of the another packet includes at least a preamble and header.

In a refinement of the first aspect the quiet period gap includes at least one channel estimation symbol.

In a refinement of the first aspect the quiet period gap includes at least one quiet symbol.

In a refinement of the first aspect the first part of the packet includes at least a preamble and a header and the third part of the another packet is void of a preamble.

In a refinement of the first aspect the first part of the packet includes at least a preamble and the third part of the another packet includes at least a preamble.

In a second aspect, there is provided a method including constructing a frame. The frame may include a packet including a first and second part, the first part separated from the second part by a gap; another packet including a third part, the third part aligned with at least a portion of the gap; and transmitting the frame. In comparison with a conventional method, at least one effect of the method of the solution provided in the second aspect is the mitigation of interference caused when two packets of a frame are transmitted on channels of a MIMO system.

In a refinement of the second aspect the transmitting transmits the frame at least in part by utilizing Orthogonal Frequency-Division Multiplexing (OFDM).

In a refinement of the second aspect the constructing constructs the first part of the packet to include at least a preamble and the third part of the another packet to include at least a preamble and header.

In a refinement of the second aspect the constructing constructs the gap to be a void.

In a refinement of the second aspect the constructing constructs the gap to include at least one quiet symbol.

In a refinement of the second aspect the constructing constructs the first part of the packet to include at least a preamble and a header and the third part of the another packet being void of a preamble.

In a refinement of the second aspect the constructing constructs the first part of the packet to include at least a preamble and the third part of the another packet to include at least a preamble.

In a third aspect, there is provided a computer-readable media storing processor-executable instructions. When executed, the instructions cause one or more processors to perform operations that facilitate successful reception of frame via a communication medium, the operations comprising: receiving a Multi-Input Multi-Output (MIMO) frame, wherein the frame includes at least two packets, a first packet of the two packets including a preamble section followed by an inter-frame gap and a second packet of the two packets including a section aligned with the inter-frame gap of the first packet; and performing a channel measurement during at least a period defined by the inter-frame gap. As compared to conventional instructions that perform operations, at least one effect of the solution provided in the third aspect is the mitigation of interference caused when two packets of a frame are received on channels of a MIMO system.

In a refinement of the third aspect a header section is subsequent to the preamble section and precedes the inter-frame gap and the section aligned with the inter-frame gap includes at least a preamble and a header.

In a refinement of the third aspect the performing performs an interference channel measurement on a first channel of the communication medium during a period delimited by the inter-frame gap and further performs information channel measurement on a second channel of the communication medium during the period delimited by the inter-frame gap.

In a refinement of the third aspect the receiving is performed at least in part by utilizing Orthogonal Frequency-Division Multiplexing (OFDM).

In a refinement of the third aspect the locating includes locating a transition other than the first transition of the multiple transitions.

In a refinement of the third aspect the inter-frame gap is an empty space.

In a refinement of the third aspect the inter-frame gap includes at least one channel estimation symbol.

In a refinement of the third aspect the inter-frame gap includes at least one quiet symbol.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

Following is a brief description of the drawings:

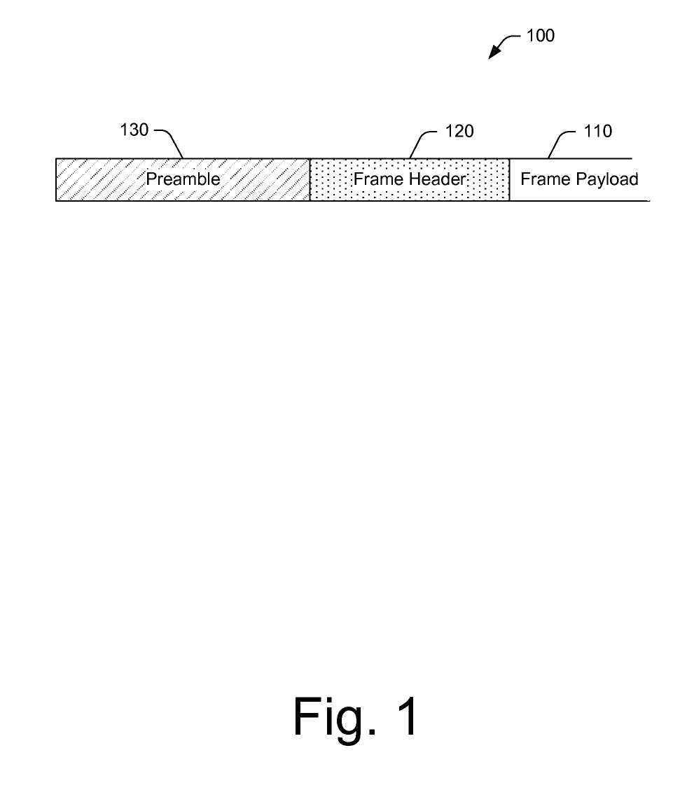

FIG. 1 illustrates a relevant portion of a typical data packet (including a preamble) used in multicarrier communications system, such as an Orthogonal Frequency-Division Multiplexing (OFDM) based system, that uses Single-Input Single-Output (SISO).

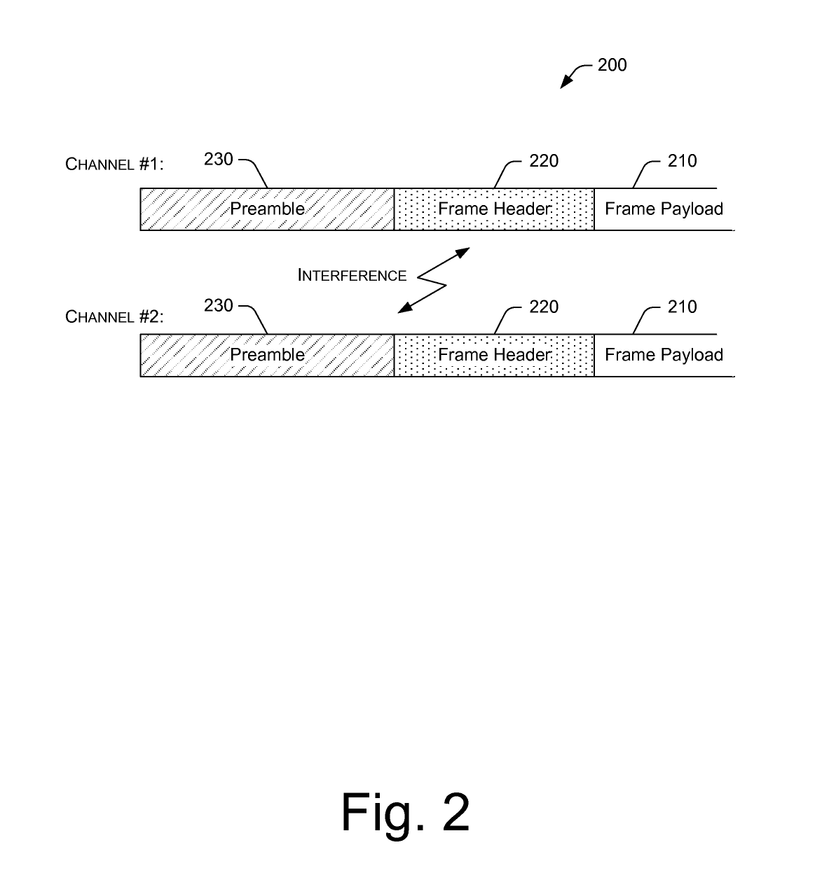

FIG. 2 illustrates a relevant portion of typical data packets (including a preamble) used in multicarrier communications system, such as an OFDM-based system, that uses Multi-Input Multi-Output (MIMO).

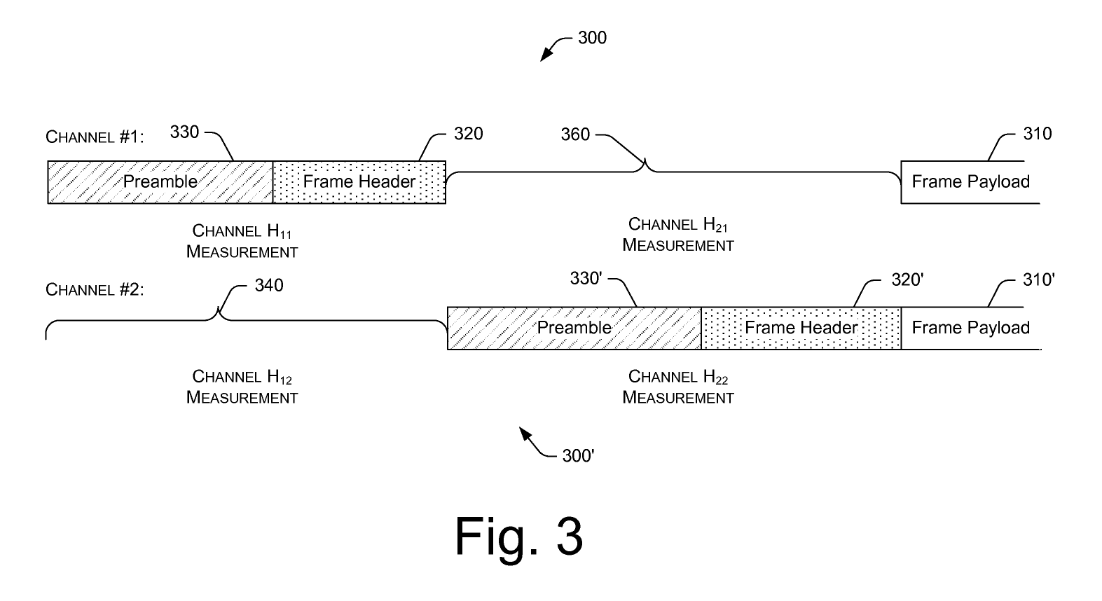

FIG. 3 illustrates a relevant portion of data packets (including a preamble) used in multicarrier communications system, such as an OFDM-based system, that uses MIMO, according to a first implementation.

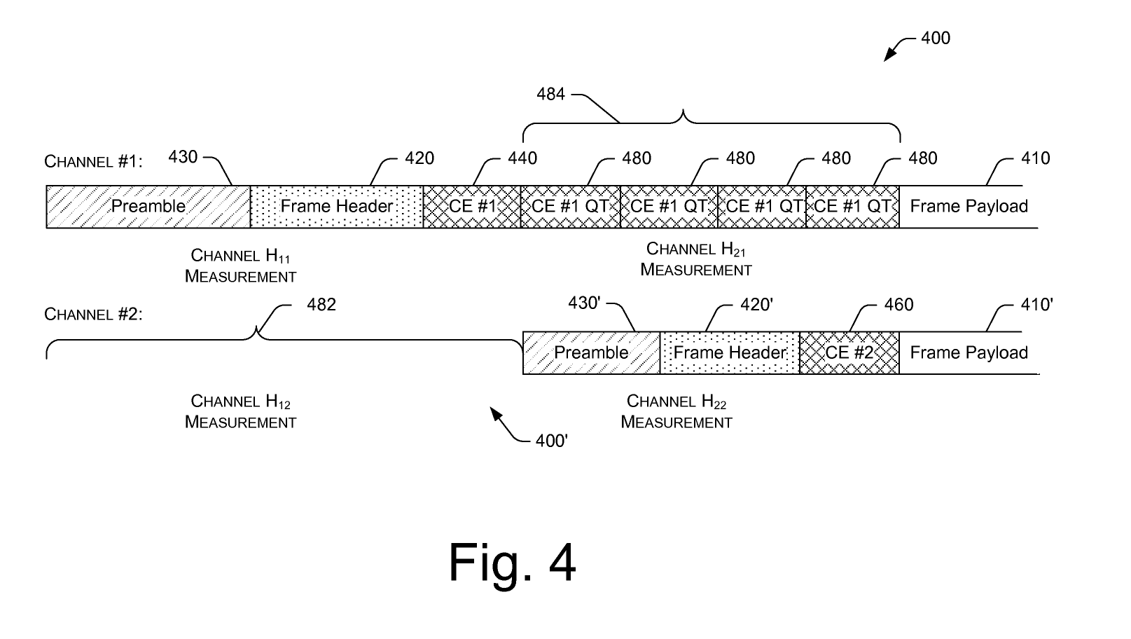

FIG. 4 illustrates a relevant portion of data packets (including a preamble) used in multicarrier communications system, such as an OFDM-based system, that uses MIMO, according to a second implementation.

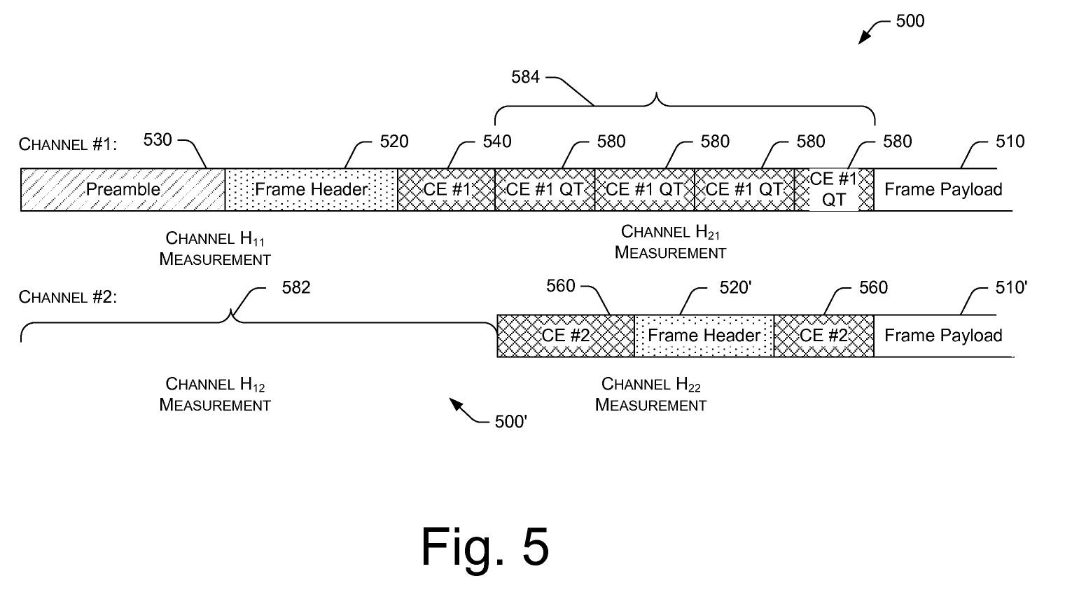

FIG. 5 illustrates a relevant portion of data packets used in multicarrier communications system, such as an OFDM-based system, that uses MIMO, according to a third implementation.

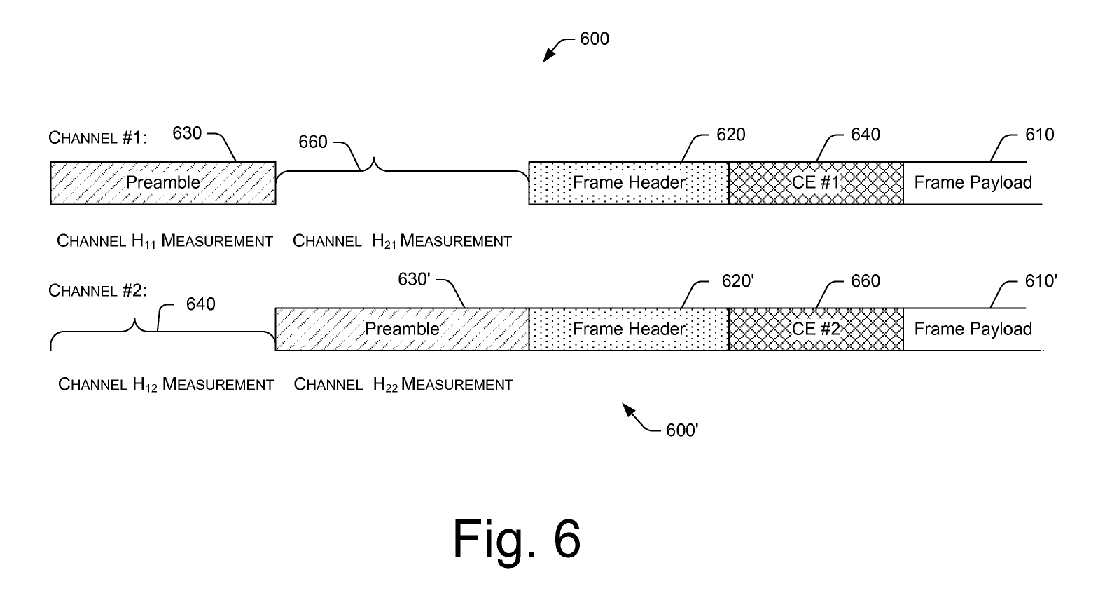

FIG. 6 illustrates a relevant portion of data packets used in multicarrier communications system, such as an OFDM-based system, that uses MIMO, according to a forth implementation.

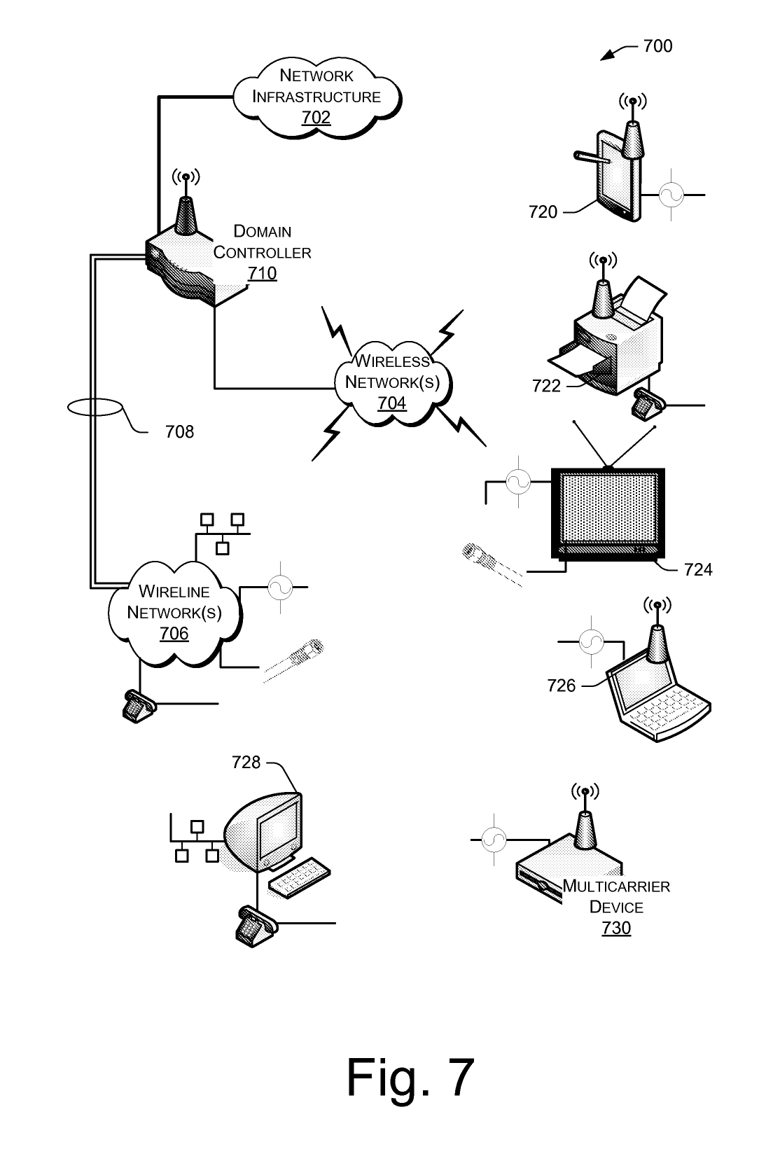

FIG. 7 shows an exemplary networking communications arrangement in which one or more implementations of the techniques described herein may be employed.

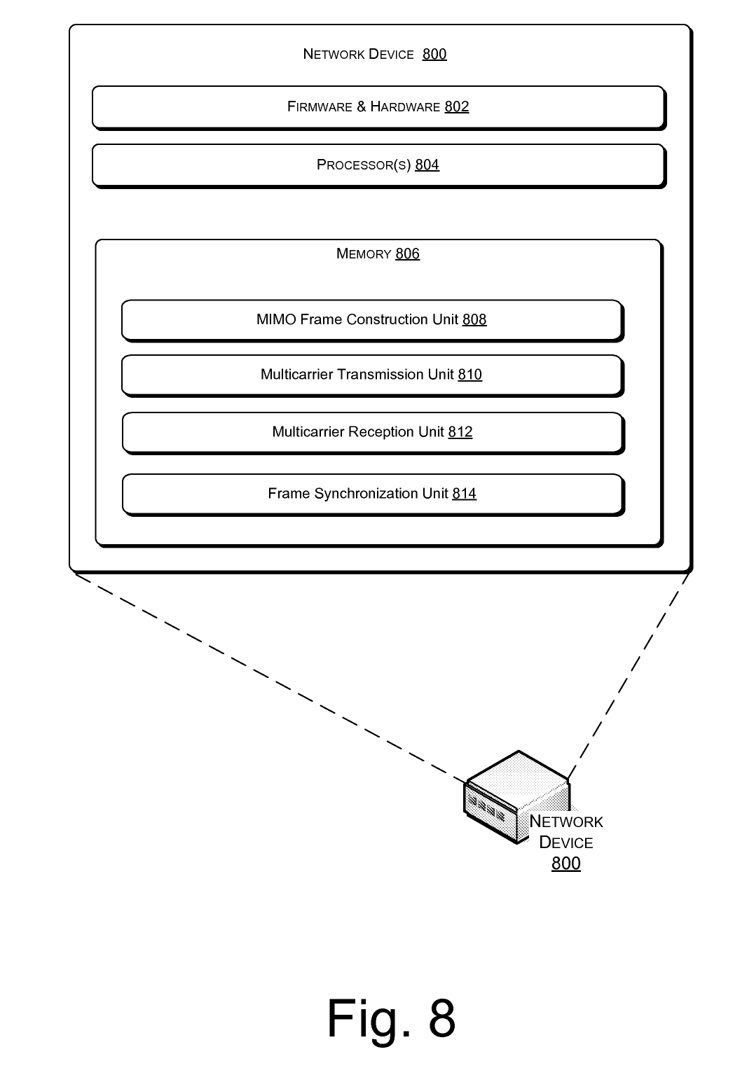

FIG. 8 illustrates an exemplary network device configured to implement the techniques described herein.

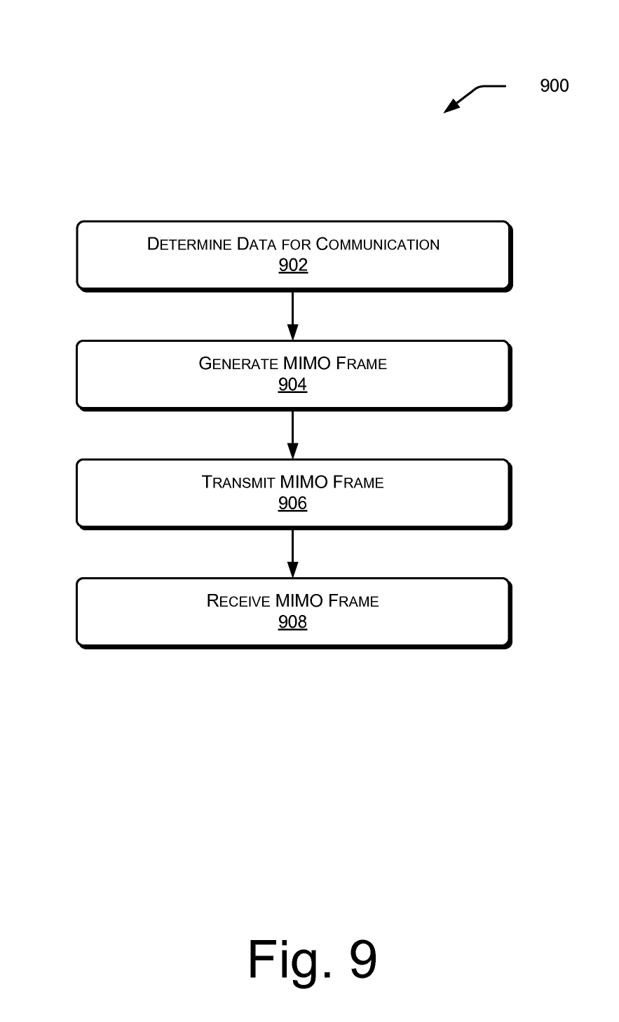

FIG. 9 is a flowchart of a process that is configured to implement the implementations described herein.

The following detailed description references the accompanying figures that are briefly described above. In the figures, the left-most digit(s) of a reference number identifies the figure in which the reference number first appears. The same numbers are used throughout the drawings to reference like features and components. Also, note that any text smaller than ten point is presented merely to indict where text would appear in the depicted figures. Since such text is merely an indicator of where text might appear, the content of such text is unimportant to the understanding the implementations depicted.

Described herein are implementations related to data communication using a frame that includes at least two data packets. One of the data packets includes a preamble that is separated from a payload by a gap (e.g., an inter-frame gap), void or empty space. Another of the data packets includes a preamble that is aligned with the gap (e.g., an inter-frame gap), void or empty space. A receiver of the frame may perform channel measurements during the gap (e.g., an inter-frame gap), void or empty space.

The described implementations are particularly useful in systems that employ Multi-Input Multi-Output (MIMO). In particular, the various frame implementations described herein enable a receiver of an implementation specific frame to reliably execute communication and interference measurements on the channels of a MIMO system. In addition, the frames implemented by the described implementations are compatible with Single-Input Single-Output (SISO) systems, support various MIMO schemes, e.g., space time diversity and spatial multiplexing, and enable simplified transceiver design.

### Exemplary Implementation and Operation

An Orthogonal Frequency-Division Multiplexing (OFDM) is used as a digital multi-carrier modulation approach for various communications media. OFDM-based networking/transmission systems utilize multiple subcarriers to transport information from one particular node to another. OFDM is sometimes referred to as multi-carrier or discrete multi-tone modulation. An OFDM-based system divides a high-speed serial information signal into multiple lower-speed sub-signals that the system transmits simultaneously at different frequencies in parallel.

The approach is orthogonal because of the spacing which prevents the demodulators from seeing frequencies other than their own. The benefits of OFDM are high spectral efficiency, resiliency to RF interference, and lower multi-path distortion. This is useful because in a typical terrestrial broadcasting scenario there are multipath-channels (i.e., the transmitted signal arrives at the receiver using various paths of different length).

FIG. 1 illustrates a relevant portion of a typical data packet 100 used in an OFDM-based system that uses SISO. The data packet 100 includes a frame that includes its payload 110 with a header 120. A preamble 130 is prepended to or associated with the frame.

The preamble 130 is the first part of the frame, and intended so that the receiver can detect the presence of the frame on the medium, adjust the gain of Analog Front End (AFE), and synchronize the clock. The header 120 carries necessary information for the receiver to address, demodulate, and decode the payload 110.

FIG. 2 illustrates a relevant portion of typical data packets 200 used in an OFDM-based system that uses MIMO. In this disclosure, multiple data packets, such as data packets 200, may be referred to as a MIMO frame or simply a frame. The channel #1 data packet includes a frame that includes a payload 210 with a header 220. A preamble 230 is prepended to or associated with the frame. Similarly, the channel #2 data packet includes a frame that includes its payload 210 with a header 220. A preamble 230 is prepended to or associated with the frame.

The preamble 230 is the first part of the frame, and intended so that the receiver can detect the presence of the frame on the medium, adjust the gain of the AFE, and synchronize the clock. The header 220 carries necessary information for the receiver to address, demodulate, and decode the payload 210.

In a MIMO system, the MIMO frame includes at least two data packets or frames that are transmitted simultaneously over two channels (e.g., channel #1 and #2). As indicated previously herein, the present disclosure generally describes MIMO frames that include two data packets. However, the described MIMO frames may also be implemented with more than two data packets in order to accommodate more than two channels.

In order to enhance transmission reliability, identical, or slightly modified (e.g., same data with different modulation) frames may be transmitted simultaneously over two channels. Alternatively, in order to increase data rate, two different frames carrying different payloads may be transmitted over two channels. The first approach is often referred to as space time diversity while the latter is referred to as spatial multiplexing.

Unfortunately, because the two channels are not perfectly orthogonal, transmission in one channel may interfere with transmission in another channel. The mutual interference may cause degradation of Virtual Carrier Sense (VCS) capability of SISO system—e.g., the decoding quality of MIMO frames at SISO receivers may be degraded. Furthermore, the mutual interference may cause decoding degradation of MIMO frames received by a MIMO receiver.

Implementations described herein provide coordinated MIMO frame structures. The implementations consider at least the following scenarios:
MIMO frames that are intended to be received by a MIMO receiver.
MIMO frames intended for different receivers, where such receivers may be SISO, SISO with interference cancellation capability, or MIMO.
   Moreover, the MIMO frames according to various implementations described herein provide:
Uncomplicated measurement of communication (H₁₁, H₂₂) and interference (H₁₂, H₂₁) channels, where H_{ab} denotes the channel measured from the transmitter at channel “a” to the receiver at channel
Backward compatibility with SISO systems with substantially no performance degradation.
Support of different MIMO schemes, e.g., space time diversity and spatial multiplexing with the same structure.
Receiver processing time that leads to simplification of receiver design.

FIG. 3 illustrates a relevant portion of data packets 300 used in an OFDM-based system that uses MIMO, in accordance with a first implementation. The channel #1 data packet 300 includes a frame that includes a payload 310 with a header 320. A preamble 330 is prepended to or associated with the frame. Similarly, the channel #2 data packet 300′ includes a frame that includes its payload 310′ with a header 320′. A preamble 330′ is prepended to or associated with the frame.

The transceiver originating the data packets 300 delays, for some quiet time duration, as defined by a gap, void or empty space, transmitting preamble 330′ and header 320′ for channel #2, as shown by bracket 340. That is, preamble 330 and header 320 for channel #1 are transmitted first on channel #1 while channel #2 is quiet. During this quiet time, the MIMO receiver may measure channel H₁₁ and H₁₂. Subsequently, preamble 330′ and header 320′ for channel #2 are transmitted while channel #1 is quiet, as defined by a gap, void or empty space, as shown by bracket 360. During this time, the MIMO receiver may measure channel H₂₂ and H₂₁.

Notably, where the gap is observed from the same channel, the gap is viewed as an intra-frame gap. In the case, where the gap is observed from another channel, then the gap is an inter-frame gap. In addition, and as shown in the FIG. 3, a second gap is shown at the beginning of the frame of channel 2. This second gap may be considered an inter-frame gap in the sense that it comes between frames on channel 2. On the other hand, the second gap shown may be within the frame on channel 2 and so considered an intra-frame gap.

The foregoing first implementation allows nodes in the domain, regardless of SISO or MIMO, to detect a MIMO frame accurately because preambles and headers are transmitted while other channels are quiet. Moreover, the scheme increases the detection probability of the MIMO frame at other nodes, since preambles and headers are transmitted twice on different channels.

In one implementation, the header 320 for channel #1 may include one or more bits that indicate that channel #2 is enabled. Also, the header 320′ for channel #2 may include one or more bits that indicate that channel #1 is enabled. In addition, the channel #1 and #2 headers 320 and 320′, respectively, may include duration information.

FIG. 4 illustrates a relevant portion of data packets 400 used in an OFDM-based system that uses MIMO, in accordance with a second implementation. The channel #1 data packet includes a frame that includes a payload 410 with a header 420. A preamble 430 is prepended to or associated with the frame. Similarly, the channel #2 data packet includes a frame that includes its payload 410 with a header 420. A preamble 430 is prepended to or associated with the frame.

It may be possible to add one or more channel estimation (CE) symbols after each header to facilitate enhanced channel estimation and to enable the receiver to have additional time to process the MIMO frame. For example, in FIG. 4, a CE #1 440 is added after the header 420 for channel #1, and a CE #2 460 is added after the header 420 for channel #2. The type and/or number of CE symbols may be controlled by each header 420, independently, via fields in the header 420.

In addition, it is possible to add one or more CE #1 quiet symbols (QT) 480 after the CE #1 440. Each CE #1 QT 480 may be considered as another form of channel estimation symbol, and any combination of different CE symbol types can be inserted between the header and the payload.

The transceiver originating the data packets 400 delays, for some quiet time duration, as defined by a gap, void or empty space, transmitting preamble 430 and header 420 for channel #2. That is, preamble 430, header 420 and CE #1 440 for channel #1 are transmitted first on channel #1 while channel #2 is quiet, which is denoted by bracket 482. During this quiet time, the receiver may measure channel H₁₁ and H₁₂. Subsequently, preamble 430, header 420 and CE #2 460 for channel #2 are transmitted while channel #1 is quiet. In this implementation, the delay is denoted by bracket 484, and substantially the entire delay period includes the CE #1 QTs 480 in a gap, void or empty space. During this quiet time, the receiver may measure channel H₂₂ and H₂₁.

The foregoing second implementation allows nodes in the domain, regardless of SISO or MIMO, to detect a MIMO frame accurately because preambles and headers are transmitted while other channels are quiet. Moreover, the scheme increases the detection probability of the MIMO frame at other nodes, since preambles and headers are transmitted twice on different channels.

In one implementation, the header 420 for channel #1 may include one or more bits that indicate that channel #2 is enabled. Also, the header 420 for channel #2 may include one or more bits that indicate that channel #1 is enabled. In addition, the channel #1 and #2 headers 420 may include duration information and information that indicates the inclusion of CE symbol(s) and the type of CE symbol(s).

FIG. 5 illustrates a relevant portion of data packets 500, 500′ used in an OFDM-based system that uses MIMO, in accordance with a third implementation. In this implementation, for example, the MIMO frame is for transmission to a MIMO receiver. The channel #1 data packet 500 includes a frame that includes a payload 510 with a header 520. A preamble 530 is prepended to or associated with the frame. Similarly, the channel #2 data packet 500′ includes a frame that includes its payload 510′ with a header 520′. In this implementation, the channel #2 does not include a preamble; a CE #2 560 (described in the following) is used in place of the preamble.

It may be possible to add one or more channel estimation (CE) symbols after each header to facilitate enhanced channel estimation and to enable the receiver to have additional time to process the MIMO frame. For example, in FIG. 5, a CE #1 540 is added after the header 520 for channel #1, and a CE #2 560 is added after the header 520′ for channel #2. The type and/or number of CE symbols may be controlled by each header 520, 520′, independently, via fields in the header 520, 520′.

In addition, it is possible to add one or more CE #1 quiet symbols (QT) 580 after the CE #1 540, within a gap, void or empty space. Each CE #1 QT 580 may be considered as another form of channel estimation symbol, and any combination of different CE symbol types can be inserted between the header and the payload.

The transceiver originating the data packets 500, 500′ delays, for some quiet time duration, as defined by a gap, void or empty space, transmitting CEs #2 560 and header 520 for channel #2. That is, preamble 530, header 520 and CE #1 540 for channel #1 are transmitted first on channel #1 while channel #2 is quiet, which is denoted by bracket 582 and defined by a gap, void or empty space. During this quiet time, the MIMO receiver may measure channel H₁₁ and H₁₂. Subsequently, CE #2 560, header 520′ and CE #2 560 for channel #2 are transmitted while channel #1 is quiet. In this implementation, the delay is denoted by bracket 584, and substantially the entire delay period includes the CE #1 QTs 580 within a gap, void or empty space. During this quiet time, the MIMO receiver may measure channel H₂₂ and H₂₁.

The foregoing third implementation allow at least one node in the domain to detect a MIMO frame accurately because portions of data packets are transmitted while other channels are quiet. Moreover, the scheme increases the detection probability of the MIMO frame at other nodes, since at least the headers are transmitted twice on different channels.

In one implementation, the header 520 for channel #1 may include one or more bits that indicate that channel #2 is enabled. Also, the header 520′ for channel #2 may include one or more bits that indicate that channel #1 is enabled. In addition, the channel #1 and #2 headers 520 and 520′, respectively, may include duration information and information that indicates the inclusion of CE symbol(s) and the type of CE symbol(s).

FIG. 6 illustrates a relevant portion of data packets 600, 600′ used in an OFDM-based system that uses MIMO, in accordance with a forth implementation. In this implementation, for example, the MIMO frame is for transmission to one or more MIMO receivers. The channel #1 data packet 600 includes a frame that includes a payload 610 with a header 620. A CE #1 640 is between the header 620 and the payload 610. A preamble 630 is associated with the frame. Similarly, the channel #2 data packet 600′ includes a frame that includes its payload 610′ with a header 620′. A CE #2 660 is between the header 620′ and the payload 610′. A preamble 630 is associated with the frame.

The transceiver originating the data packets 600 delays, for some quiet time duration, as defined by a gap, void or empty space, transmitting preamble 630′, header 620′ and CE #2 660 for channel #2, as shown by bracket 640. That is, preamble 630 for channel #1 is transmitted first on channel #1 while channel #2 is quiet. During this quiet time, the MIMO receiver may measure channel H₁₁ and H₁₂. Subsequently, preamble 630′ is transmitted while channel #1 is quiet, as defined by a gap, void or empty space, as shown by bracket 660. During this time, the MIMO receiver may measure channel H₂₂ and H₂₁.

The foregoing forth implementation allows nodes in the domain to detect a MIMO frame accurately because preambles are transmitted while other channels are quiet. Moreover, the scheme increases the detection probability of the MIMO frame at other nodes, since preambles and headers are transmitted twice on different channels.

In one implementation, the header 620 for channel #1 may include one or more bits that indicate that channel #2 is enabled. Also, the header 620 for channel #2 may include one or more bits that indicate that channel #1 is enabled. In addition, the channel #1 and #2 headers 620 may include duration information and further information indicating the type and number of implemented CEs.

In alternative implementations, the use of orthogonal signaling in preambles of two or channels may be beneficial to achieve better efficiency. That is, a preamble for a channel #1 and a preamble for a channel #2 may be transmitted concurrently, but the preambles are constructed so that they are orthogonal. The headers for the channels #1 and #2 may also be transmitted concurrently. Furthermore, each data packet of the MIMO frame may include a CE QT and a CE. For example. a first data packet of a MIMO frame may include a preamble, a header, a CE QT, CE and payload, and a second packet of the MIMO frame may include a preamble, header, CE, CE QT and payload. The first and second data packets of the MIMO frame may be transmitted concurrently.

Moreover, in one or more implementations, the header information to decode a MIMO frame (e.g., payload) is split into the channel #1 header and the channel #2. However, in one or more implementations, this split is not necessary. Depending on the use case or supporting application, the header information may be carried on the channel #1 header or the channel #2 header, removed entirely, or unevenly split between the channel #1 header or the channel #2 header.

### Exemplary Network Communications Arrangement

An exemplary communication arrangement may employ at least two multicarrier apparatuses or nodes. The exemplary communication arrangement may also employ a multicarrier controller apparatus or controller node. In one implementation, the multicarrier apparatuses/controller are OFDM apparatuses capable of implementing the herein described techniques and implementations. In another implementation, the exemplary communication arrangement employs apparatuses or nodes that communicate via a wired/wireless medium by way of one or more communication protocols.

The multicarrier apparatuses may communicate through a communication channel. The communication channel may be realized as one or more wireless communication media, one or more wireline communication media (e.g., coaxial cable, twisted pair of copper wires, powerline wiring, Ethernet cabling, optical fiber, etc.), or combinations thereof. Accordingly, the multicarrier apparatuses may include structure and functionality that enable signal communication over such media. Such structure and functionality may include one or more antennas, integrated wireline interfaces, and the like. Such structure and functionality may employ multiple differing wireline media (e.g., coaxial cable and powerline wiring). Depending on the implementation, the multicarrier apparatuses may communicate with one another directly (peer-to-peer mode) or the multicarrier apparatuses may communicate via the controller apparatus. The multicarrier apparatuses may be SISO and/or MIMO capable devices.

A family of networking standards called G.hn has been proposed by the International Telecommunication Union's Standardization arm (ITU-T) and promoted by the HomeGrid Forum. One or more of the G.hn specifications define networking over both wireline (e.g., powerlines, phone lines and coaxial cables) and wireless networks. The G.hn specifications specify standards by which multicarrier apparatuses may communicate via such communications channels. The techniques described herein may be employed with those G.hn specifications or other specifications.

FIG. 7 shows an exemplary networking communications arrangement 700 in which one or more implementations may be employed. The multicarrier controller apparatus of the arrangement 700 is an access point 710 of a home networking environment. As shown in FIG. 7, the access point 710 may be a residential gateway that distributes broadband services from a connected network infrastructure 702 (e.g., the Internet) to various multicarrier apparatuses via one or more wireless networks 704 and one or more wireline networks 706. The wireless networks 704 may also be called wireless local area networks (WLAN) and the wireline networks 706 may be called local area networks (LANs).

The various multicarrier apparatuses depicted in FIG. 7 include a tablet computer 720, a network printer 722, a television 724, a laptop computer 726, a desktop computer 728, and a generic multicarrier apparatus or device 730 (e.g., a digital video recorder (DVR) and Internet TV device). The multicarrier apparatuses may be associated with digital content destinations in the home, but may also be associated with digital content sources, such as digital video recorders (DVR), computers providing streaming video, televisions, entertainment centers, and the like.

As depicted, the tablet computer 720 is configured to communicate via both wireless and powerline wireline networks, the network printer 722 is configured to communicate via wireless and/or twisted-pair cabling (e.g., telephone wiring) based wireline networks, the television 724 is configured to communicate via either of two different wireline networks (e.g., coaxial cabling and/or powerline cabling based), the laptop computer 726 communicates via powerline based wireline and/or wireless networks, and the desktop computer 728 is configured to communicate via an Ethernet cabling based wireline network and/or twisted-pair cabling (e.g., telephone wiring) based wireline networks. Similarly, the multicarrier device 730 is configured to communicate via wireless and/or powerline-based wireline networks. As depicted, the wireline networks 706 include one or more wireline networks based upon Ethernet cabling (e.g., Cat-5), powerline wiring, coaxial cabling, and/or telephone cabling. As represented by multiple wire connections 706, the domain controller 710 is connected via multiple different wirings to the multiple different wireline networks 706.

Furthermore, the multicarrier apparatuses may be enabled to communicate using packet-based technology (e.g., ITU G.hn, HomePNA, HomePlug® AV and Multimedia over Coax Alliance (MoCA)) and xDSL technology). Such xDSL technology may include Asymmetric Digital Subscriber Line (ADSL), ADSL2, ADSL2+, Very high speed DSL (VDSL), VDSL2, G.Lite, and High bit-rate Digital Subscriber Line (HDSL). In addition, some multicarrier apparatuses (such as 620, 622, 626, and 630) may be enabled to communicate using IEEE 802.11 and IEEE 802.16 (WiMAX) wireless technologies.

Signals exchanged between the multicarrier apparatuses may include multicarrier symbols that each include a plurality of tones or sub-channels. Each of the tones within a multicarrier symbol may have data bits modulated thereon that are intended for delivery from one of the multicarrier apparatuses to another.

### Exemplary Network Device Employing Robust Preamble Techniques

FIG. 8 shows an exemplary network device 800 configured to employ the implementations described herein. The network device 800 may be, for example, a network controller, a multicarrier controller apparatus (such as the access point 710 in FIG. 7), and/or a multicarrier apparatus (such as 720-730 of FIG. 7).

The network device 800 is depicted, in FIG. 8, in an expanded view to better show some of the relevant components therein. The network device 800 may include firmware & hardware 802, one or more processors 804, and a memory 806. The network device 800 has one or more modules of processor-executable instructions stored in the memory 806. The network device 800 may include a preamble construction unit 808, a multicarrier transmission unit 810, a multicarrier reception unit 812, and a frame synchronization unit 814.

The MIMO frame construction unit 808 constructs a MIMO frame, at least in part, in accordance with one or more of the implementations described herein. When constructed, the MIMO frame may have at least two at least two data packets for transmission to one or more receivers.

The multicarrier transmission unit 810 is configured to transmit the MIMO frame over a communications medium. That communication medium may be a communication medium, such as a powerline. An OFDM transceiver is an example of a suitable device for the multicarrier transmission unit 810.

The multicarrier reception unit 812, such as the OFDM transceiver, receives a MIMO frame having a structure in accordance with at least one implementation described herein and via a communications medium, such as powerline.

The frame synchronization unit 814 monitors the incoming preambles of a MIMO frame. Based upon one or more preambles, the unit 814 calculates/predicts when the frame will start. The reception unit 812 can begin receiving the frame at the predicted time.

While the network device 800 is described herein in terms of modules and sub-modules of processor-executable instructions, the functionalities of these modules and sub-modules may be implemented in software, hardware, firmware, or a combination thereof.

### Exemplary Processes

FIG. 9 is a flowchart illustrating an exemplary process 900 that implements the implementations described herein. The exemplary process 900 may be performed, at least in part, by a networking device such as a multicarrier controller apparatus (e.g., the domain controller 710 or television 724 of FIG. 7), a multicarrier apparatus (e.g., the device 730 of FIG. 7), and/or network device 800 of FIG. 8. Operation of the process 900 may reference previously introduced elements and description related to the drawing figures, such as FIGS. 1-8.

FIG. 9 includes process 900, which generates a MIMO frame in accordance with the implementations described herein. Typically, this process 900 is performed by a network device performing a multicarrier transmission over a communication medium, such as powerline.

At 902, the process 900 begins with determining that data are for communication to a receiver, such as a multicarrier device (e.g., network device 800).

At 904, the multicarrier device generates a MIMO frame in accordance with one of the implementations described herein. For example, the MIMO frame may generated as illustrated in FIGS. 3-6.

At 906, the multicarrier device transmits the MIMO frame generated at block 904 on a communication medium, such as powerline.

At 908, a multicarrier device receives the MIMO frame via the communication medium.

### Additional and Alternative Implementation Notes

Exemplary implementations discussed herein may have various components collocated; however, it is to be appreciated that the various components of the arrangement may be located at distant portions of a distributed network, such as a communications network and/or the Internet, or within a dedicated secure, unsecured and/or encrypted arrangement. Thus, it should be appreciated that the components of the arrangements may be combined into one or more apparatuses or collocated on a particular node of a distributed network, such as a telecommunications network. Moreover, it should be understood that the components of the described arrangements may be arranged at any location within a distributed network without affecting the operation of the arrangements. Similarly, one or more functional portions of the arrangement may be distributed between a modem and an associated computing device.

The above-described implementations, arrangements, apparatuses and methods may be implemented in firmware, hardware, software, one or more software modules, one or more software and/or hardware testing modules, one or more telecommunications test devices, one or more DSL modems, one or more ADSL modems, one or more xDSL modems, one or more VDSL modems, one or more linecards, one or more G.hn transceivers, one or more MOCA transceivers, one or more Homeplug transceivers, one or more powerline modems, one or more wired or wireless modems, test equipment, one or more multicarrier transceivers, one or more wired and/or wireless wide/local area network systems, one or more satellite communication systems, network-based communication systems (such as an IP, Ethernet or ATM system), one or more modems equipped with diagnostic capabilities, or the like, or on one or more separate programmed general purpose computers having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G.hn, Homeplug or the like.

Additionally, the implementations, arrangements, procedures and protocols of the described implementations may be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable device, or the like. In general, any apparatus capable of implementing a state machine that is in turn capable of implementing the methodology described and illustrated herein may be used to implement the various communication methods, protocols and techniques according to the implementations.

Furthermore, the disclosed implementations and procedures may be readily implemented in software using object or object-oriented software development environments that provide a portable source code that can be used on a variety of computer or workstation platforms. Alternatively, the disclosed arrangements may be implemented partially or fully in hardware using standard logic circuits or VLSI design. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed procedures may be readily implemented in software that can be stored on a computer-readable storage medium, executed on a programmed general-purpose computer with the cooperation of a controller and memory, a special purpose computer, a microprocessor, or the like. In these instances, the arrangements and procedures of the described implementations may be implemented as a program embedded on a personal computer such as an applet, JAVA® or CGI script, as a resource residing on a server or computer workstation, as a routine embedded in a dedicated communication arrangement or arrangement component, or the like. The arrangements may also be implemented by physically incorporating the arrangements and/or procedures into a software and/or hardware system.

The implementations herein are described in terms of exemplary embodiments. However, it should be appreciated that individual aspects of the implantations may be separately claimed and one or more of the features of the various embodiments may be combined. In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein are illustrated as a collection of blocks in a logical flow graph, which represents a sequence of operations that can be implemented with hardware, software, firmware, or some combination thereof. In the context of software/firmware, the blocks represent instructions stored on one or more processor-readable storage media that, when executed by one or more processors, perform the recited operations. The operations of the exemplary processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like. Moreover, the described implementations may be similarly executed and realized by way of such hardware, software, firmware, or some combination thereof.

Note that the order in which the implementations and processes are described is not intended to be construed as a limitation, and any number of the described implementations and processes may be combined.

The term “processor-readable media” includes processor-storage media. For example, processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

For the purposes of this disclosure and the claims that follow, the terms “coupled” and “connected” may have been used to describe how various elements interface. Such described interfacing of various elements may be either direct or indirect.

1. A method for constructing a frame including data for transmission over a telecommunications network, the method comprising the steps of:
constructing a Multi-Input Multi-Output (MIMO) frame including:
a packet having a first part and a second part, the first part separated from the second part by a gap;
another packet including a third part, the third part aligned with at least a portion of the gap; and
transmitting the frame over the telecommunications network.

2. The method according to claim 1, wherein the step of transmitting transmits the MIMO frame according to a protocol, selected from the group consisting of G.hn, G.hnem, IEEE 1901, and HomePlug AV.

3. The method according to claim 1, wherein the step of transmitting transmits the MIMO frame at least in part by utilizing Orthogonal Frequency-Division Multiplexing (OFDM).

4. The method according to claim 1, wherein the step of constructing constructs the first part of the packet to include at least a preamble and the third part of the another packet to include at least a preamble and header.

5. The method according to claim 1, wherein the step of constructing constructs the gap to be a void.

6. The method according to claim 1, wherein the step of constructing constructs the gap to include at least one quiet symbol.

7. The method according to claim 1, wherein the step of constructing constructs the first part of the packet to include at least a preamble and a header and the third part of the another packet being void of a preamble.

8. The method according to claim 1, wherein the step of constructing constructs the first part of the packet to include at least a preamble and the third part of the another packet to include at least a preamble.

9. The method according to claim 1, further comprising the step of performing a channel measurement during at least a period defined by the gap.

10. The method according to claim 1, wherein the performing performs an interference channel measurement on a first channel of the communication medium during a period delimited by the gap and further performs information channel measurement on a second channel of the communication medium during the period delimited by an inter-frame gap.

11. The method according to claim 10, wherein the inter-frame gap includes at least one of group comprising: an empty space, a channel estimation symbol, and a quiet symbol.

12. A computer-readable media storing processor-executable instructions that when executed, cause one or more processors to perform operations in a method according to claim 1.

13. An apparatus comprising:
a frame construction unit configured to construct a Multi-Input Multi-Output (MIMO) frame including:
a packet including a first and second part, the first part separated from the second part by a gap; and
another packet including a third part the third part aligned with at least a portion of the gap.

14. The apparatus according to claim 13, wherein the frame construction unit is configured to transmit the MIMO frame at least in part by utilizing Orthogonal Frequency-Division Multiplexing (OFDM).

15. The apparatus according to claim 13, wherein the frame construction unit is configured to construct the first part of the packet to include at least a preamble and the third part of the another packet to include at least a preamble and header.

16. The apparatus according to claim 13, wherein the frame construction unit is configured to construct the gap as a void.

17. The apparatus according to claim 13, wherein the frame construction unit is configured to construct the gap to include at least one quiet symbol.

18. The apparatus according to claim 13, wherein the frame construction unit is configured to construct the first part of the packet to include at least a preamble and a header and the third part of the another packet being void of a preamble.

19. The apparatus according to claim 13, wherein the frame construction unit is configured to construct the first part of the packet to include at least a preamble and the third part of the another packet to include at least a preamble.

20. The apparatus according to claim 13, wherein the frame construction unit has associated therewith a unit that performs a channel measurement during at least a period defined by the gap.

21. The apparatus according to claim 13, wherein frame construction unit has associated therewith a unit that transmits the MIMO frame according to a protocol, selected from the group consisting of G.hn, G.hnem, IEEE 1901, and HomePlug AV.

22. The apparatus according to claim 13, wherein frame construction unit is configured to arrange a header section subsequent to the preamble section and precedes the gap and the section aligned with the gap includes at least a preamble and a header.

23. The apparatus according to claim 13, wherein the frame construction unit has a unit associated therewith that performs an interference channel measurement on a first channel of the communication medium during a period delimited by the gap and further performs information channel measurement on a second channel of the communication medium during the period delimited by the inter-frame gap.

24. The apparatus according to claim 22, wherein the inter-frame gap includes at least one of group comprising: an empty space, a channel estimation symbol, and a quiet symbol.
